(19) United States
(12) Patent Application Publication
(10) Pub. No.: US 2009/0143065 A1
(43) Pub. Date: Jun. 4, 2009

(54) RADIO CELL PERFORMANCE MONITORING AND/OR CONTROL BASED ON USER EQUIPMENT POSITIONING DATA AND RADIO QUALITY PARAMETERS

(75) Inventor: Jyrki MATTILA, Oulu (FI)

Correspondence Address: STAAS & HALSEY LLP, SUITE 700, 1201 NEW YORK AVENUE, N.W., WASHINGTON, DC, 20005, US

(73) Assignee: NOKIA SIEMENS NETWORKS GMBH & CO. KG, MUNICH (DE)

(21) Appl. No.: 12/325,398

(22) Filed: Dec. 1, 2008

(30) Foreign Application Priority Data
Nov. 29, 2007 (EP) 07023184

(51) Int. Cl. H04W 24/00; H04W 4/00; H04W 4/02

(52) U.S. Cl. 455/423; 370/328; 455/456.1

(57) ABSTRACT

In broadband networks for fixed or cellular mobile radio access using the ETSI/BRAN standard, such as UTRANs, Wi-Fi or WLAN wireless communication networks, continuously monitored user equipment positioning data and radio link parameters indicating quality of service of a wireless link between a base transceiver station located in a mobile radio cell of the wireless cellular network and a mobile terminal connected to and being served by the base transceiver station, such as signal-to-noise-plus-interference ratio, power class and bit error rate in uplink and/or downlink direction of the wireless link, may be used for radio cell performance monitoring and/or control. By tracking current positions of user equipment (UE) served by the network, the network can offer location-based services to the UE. A network management system with an integrated alarm signaling unit and having access to a base transceiver station's link performance monitoring system and/or location measurement unit may be used.

### CROSS REFERENCE TO RELATED APPLICATIONS

This application is based on and hereby claims priority to European Application No. 07023184 filed on Nov. 29, 2007, the contents of which are hereby incorporated by reference.

### BACKGROUND

Described below is a method of radio cell performance monitoring and/or control in broadband fixed radio access networks or broadband cellular mobile radio access networks according to the ETSI/BRAN standard, such as Universal Terrestrial Radio Access Networks (UTRANs), or any other type of wireless communication network according to the Wi-Fi or WLAN standard (e.g. Bluetooth, IEEE 802.11 or HiperLAN), the GSM/GPRS standard or the UMTS standard. Thereby, continuously monitored user equipment positioning data and radio link parameters indicating the quality of service (QoS) of a wireless link between a base transceiver station (BTS) located in a mobile radio cell of the wireless cellular network and a mobile terminal (MT) connected to and being served by the base transceiver station, such as e.g. the signal-to-noise-plus-interference ratio (SINR), power class and bit error rate (BER) in uplink and/or downlink direction of the wireless link, may be used for radio cell performance monitoring and/or control. By tracking the current positions of all mobile terminals which are served by the network, hereinafter also referred to as user equipment (UE), the network is able to support location-based services offered to these mobile terminals.

A network management system with an integrated alarm signaling unit may be used which has access to a base transceiver station's link performance monitoring system and/or location measurement unit (LMU), wherein the latter is used for measuring current UE positioning information signals that are transmitted from a standard mobile terminal or specific wireless user equipment via the air interface of a fixed or mobile radio access network (RAN) to a base transceiver station of the network. The system is thereby founded upon (but not limited to) the expectation that UE positioning features will become more accurate, reliable and common in the future and that UE positioning will eventually be “business as usual”.

Fourth generation mobile networks will allow end users to roam over different network technologies, such as based on the UMTS, CDMA2000 and Wi-Fi standard. These networks make it possible to determine the location of the mobile terminal, which can then be used by diverse service applications to provide enhanced wireless services. Thereby, each mobile network technology has its own specific way to determine a mobile terminal's location and to provide this information to the end user or to a mobile application.

Getting to know the current position and eventually the current velocity of a moving mobile terminal, such as e.g. a mobile phone or personal digital assistant (PDA), does not only mean for the user being provided with valuable information, but is also necessary and useful for many operations during the connection setup of a wireless link. Cellular telecommunication systems can be equipped to perform a number of different positioning methods to enable location services to cellular subscribers. In the following, different methods for allowing UE positioning in mobile radio systems and some well-chosen UE positioning systems (such as e.g. Cell-ID, Ecell-ID, A-GPS, OTDOA-IPDL, UTDOA, RTD and ADOA) and application scenarios<A[applications|utilization]> shall at least briefly be mentioned.

The exact position of a mobile terminal is especially needed for selecting a base transceiver station<A[base station|base transceiver station]> when establishing a wireless connection (resource management), executing a handover to another base transceiver station<A[base station|base transceiver station]> during an existing wireless link used for transferring text messages, speech data, audio or video data via the air interface, performing a distance<A[distance|removal]>---------based power control, providing location-based services, network planning and QoS maintenance dependent on the current location of a mobile network subscriber's mobile terminal or for calculating mobile communication charges (home zone, long-distance calls,<A[long-distance calls|telephone calle|trunk calle]> etc.).

Aside from their physical methods of measurement and their<A[their|her]> accuracy, the different methods for detecting the current position of a subscriber's mobile terminal (MT) differ in the node of the underlying mobile radio system at which wireless RF signals are measured and at which node the current position of this mobile terminal is calculated. In particular, these nodes may e.g. be base transceiver stations<A[base stations|base transceiver station]> or specific location measurement units and location servers.

Today's UE positioning methods as known from the related art can be classified into a variety of distinct patent classes: from mobile dialing systems (H04Q), data transfer (H04B), radio direction finding and navigation systems (G01S), security tasks (G08G/B), automotive technology (B60R, B61L) up to medicine (A). Applications<A[applications|utilization]> where a mobile radio system is used for transferring UE positioning data in combination with the satellite-based Global Positioning System (GPS), however, cover a considerably larger field.

The most important UE positioning methods are described in “Stage 2 Functional Specification of User Equipment (UE) Positioning in UTRAN” (3GPP TS 25.305, 3rd Generation Partnership Project) by the Technical Specification Group Radio Access Network and, at least partially, in “The GSM System for Mobile Communications” (Cell & Sys., Palaiseau (France), 1992, ISBN 2-9507190-0-7) by M. Mouly and M. Pautet. At least some of them will be briefly described in the following sections.

A cellular mobile radio network<A[land mobile network|mobile communication network|mobile radio network]> typically consists<A[consists|exists]> of a number of mobile radio cells whose respective sizes are given by the radio coverage range of a base transceiver station which is located in the center of the respective cell<A[base station|base transceiver station]>. If this range is subdivided into sectors by directional antennas, these sectors respectively constitute a mobile radio cell. When a mobile terminal is switched on, it dials into a mobile radio cell of the cellular network which provides best reception quality. The mobile terminal thereby receives a unique cell identifier (cell ID) via a mobile radio channel and uses these and other data (e.g. synchronization information) to communicate with the base transceiver station<A[base station|base transceiver station]> of the mobile radio cell and to register itself<A[itself|himself|herself]> in the respective cell. The cell identifier for the mobile radio cell into which the mobile terminal is dialed is also sent to a data base such that the system knows at any time over which base transceiver station(s) a mobile terminal can be called and to which destination node an incoming call<A[call|reputation]> has to be routed.

A relatively simple method for providing positioning information is therefore to use a cell-ID based positioning method which uses a cell identifier referring to the mobile radio cell of the wireless cellular network where the user equipment is currently located. As the positions of the base transceiver stations<A[base stations|base transceiver station]> are known to the mobile radio system, the current position of the mobile terminal can easily be determined by a cell identifier which refers to the cell where the user equipment is currently located. More precisely, a description of the geographical area covered by the cell which is related to the cell-ID, also referred to as Geographical Area Information (GAI), is used to find out the current position of the UE. The GAI identifies the geographical area of the respective cell and is represented by a polygon. This implies that the location of a UE can be determined by identifying the mobile radio cells, or one of these cells, where the UE is currently located and by associating the identity of the cell or cells with the GAI. The position of the mobile terminal is hence determined with cell granularity. In case of a radio access network (RAN), the radio network controller (RNC) typically determines a 3-15 corner polygon that defines the geographical extension of the cell. The corners of this polygon are given as latitude-longitude pairs in the WGS114 geographical reference system. However, the size of a cell strongly varies due to the network planning, such that the accuracy of the position can lie between 100 meters in urban areas with high subscriber density and up to <A[up to|until]> 35 kilometers in peripheral and rural areas. Furthermore, the mobile terminal may also receive cell identifiers of neighboring cells via other wireless links, so as to be able, in case of a degradation<A[degradation|deterioration]> of reception quality in the current cell, to rapidly and without any loss of data execute a handover to a base transceiver station of an adjacent mobile radio cell.

Enhanced cell-ID (Ecell-ID) positioning augments the Cell-ID positioning with auxiliary information that narrows down the area which is determined by the cell polygon. The most useful method in the wideband code division multiple access (W-CDMA) system is the round trip time (RTT) measurement. This measurement determines the travel time, back and forth, from the base transceiver station to the UE and back. Using the speed of light, the distance from the known position of the base transceiver station to the UE can be calculated, the distance defining a circular stripe around the base transceiver station where the UE is located, wherein the thickness of this stripe is given by the measurement uncertainty. The Ecell-ID method is obtained by noticing that the UE is located both in the respective mobile radio cell and in the circular stripe. Hence, the UE is located in the intersection of these two geographical regions.

If there is no precise positioning information available for a call<A[call|reputation]> setup, DE 199 44 007 A1 describes that a radio paging signal is transmitted by the respective Mobile Switching Center (MSC) before establishing the connection. Based on the reply of the mobile terminal, the serving base transceiver station<A[base station|base transceiver station]> can be found and the call can precisely be directed to the corresponding base transceiver station<A[base station|base transceiver station]>.

DE 100 04 738 C1 uses a cell identifier to determine the pre-dial code of a current local fixed network. This pre-dial code is automatically put before the dialed fixed network number without requiring any cooperation of the user. A mobile subscriber is thus enabled to call a fixed network subscriber whose pre-dial code is not known to him though knowing his/her dial number.

An international pre-dial code and a network pre-dial code of the home network are automatically selected in accordance with DE 197 11 096 A1 and employed for the setup of a communication link if the mobile terminal finds out that it is located abroad.

Due to the dependency between the signal strength of a wireless RF signal that is received from a mobile terminal located in a mobile radio cell of a wireless cellular network and the distance<A[distance|removal]> of the receiving base transceiver station to the respective mobile terminal, signal strength measurements<A[base stations|base transceiver station]> can lead to a more precise UE positioning, which is due to the fact that the positions of the base transceiver stations in the particular mobile radio cells are known. When the signal strength of a wireless RF signal received from a mobile terminal is measured, one ideally obtains (when assuming line-of-sight connection) a circle around the location of the receiving base transceiver station for a given set of all positions where a mobile terminal whose current position is searched can possibly be located, which is due to the unique relationship between the signal strength and the distance<A[distance|removal]> of the mobile terminal to the receiving base transceiver station<A[base station|base transceiver station]>.

In DE 195 33 472 A1, signal strengths of wireless RF signals received from a mobile terminal are predicted by its serving base transceiver station<A[base station|base transceiver station]> as well as by its neighboring terminals and correlated with corresponding measurements of the respective mobile terminal. After that, a similarity measure is calculated. Finally, a position is assigned to the mobile terminal where the correlation coefficient takes on its maximum value. As shown in DE 102 32 177 B3, the computational effort of this procedure can be decreased when the search space is restricted based on the minimum received signal strengths of the base transceiver stations<A[base stations|base transceiver station]>. The accuracy of the respectively applied UE positioning method can be increased by using hybrid methods where e.g. the angle of bearing is additionally determined by using a directional antenna (DE 101 61 594 A1).

Assisted GPS (A-GPS) positioning is an enhancement of the US military global positioning system (GPS). Thereby, GPS reference receivers which are e.g. attached to a cellular communication system are used for collecting assistance data which, when transmitted to GPS receivers in terminals connected to the cellular communication system, enhances the performance of the GPS terminal receivers. Typically, A-GPS accuracy can become as good as 10 meters. The accuracy becomes worse in dense urban areas and indoors, where sensitivity is often not high enough for detecting very weak signals from the GPS satellites.

In the time difference of arrival (TDOA) positioning method, the propagation time of a wireless RF signal transmitted from a mobile terminal to a base transceiver station<A[base station|base transceiver station]> is measured. This time is then converted into a distance<A[distance|removal]> by calculating the product of the propagation time with the velocity of light. The problem is thereby to achieve an exact synchronization of transmitter and receiver, since smallest deviations in time may lead to considerable errors as to the distance value. Although mobile terminal and base transceiver station can be synchronized with the GPS system time, this is relatively expensive, in particular as far as concerns the mobile terminal.

A quite good positioning accuracy of approximately 50 meters can be accomplished by using the downlink time difference of arrival (OTDOA) positioning method, which refers to a positioning method that, similar to A-GPS, relies on measuring the observed time difference of arrival (OTDOA) of a mobile terminal's wirelessly transmitted signals that are received at the location measurement units (LMUs) of the corresponding base transceiver station which is connected to the mobile terminal via the air interface <A[base stations|base transceiver station]>. The LMUs must either be synchronized (e.g. with GPS), or the time deviation has to be calculated by using the LMUs for mutually measuring the time difference, thereby knowing the distances of the LMUs from each other. The OTDOA-IPDL method thereby performs UE measurements of pilot signals transmitted from several base transceiver stations. The measurement results are signaled to the RNC, where a hyperbolic trilateration method is used for calculating the position of a UE. In order to enhance the hearability of the radio base transceiver stations in the UE, there is a possibility to use idle periods in the downlink (IPDL) in order to attenuate the transmissions from the base transceiver station to which the UE is connected. This reduces the interference and hence enhances the hearability of other radio base transceiver stations. A tentative advantage with OTDOA-IPDL is that it theoretically provides a better indoor coverage than does A-GPS.

Uplink time difference of arrival (UTDOA) is a positioning method which is currently under standardization within the 3GPP organization. It is comparable to A-GPS in that it relies on time difference of arrival measurements. However, the UTDOA method uses BTS (or separate LMU) measurements of signals transmitted from the positioned UE. The transmitted signal is detected in a number of base transceiver stations or LMUs, after which the measured results are signaled to a positioning node where the position of the UE is determined by a trilateration method. In order to be able to detect the time of arrival from measurements of opportunity from the UE, a reference signal first needs to be created in a master LMU or master BTS. This is done by decoding of the signal, followed by reconstruction of the chip stream which then forms the reference signal. An advantage of UTDOA positioning is that it provides a better indoor coverage than does A-GPS.

A further possibility for obtaining UE positioning information is offered by the round trip delay (RTD) positioning method, which measures the time delay for the propagation of a wireless RF signal transmitted from the mobile terminal which is located in a mobile radio cell of the wireless cellular network to the corresponding base transceiver station which serves the mobile terminal. This method can also be carried out without having a base transceiver station being synchronized to the mobile terminal<A[base stations|base transceiver station]>. According to this method, the time which is required by a wireless RF signal transmitted by the mobile terminal to arrive at the base transceiver station<A[base station base transceiver station]> and return back to the mobile terminal is measured. Thereby, transit time within the base transceiver station<A[base station base transceiver station]> and the processing time in the mobile terminal are estimated. Since these times may greatly differ, depending on the respective manufacturer, this method does not provide a high level of exactness.

Another approach for positioning user equipment in mobile radio cells of a wireless cellular network is given by the angle difference of arrival (ADOA) technique, which is known as a method for determining the angle of arrival of an incoming electromagnetic wave received from a mobile terminal at the locations of base transceiver stations which are connected to the mobile terminal via the air interface. When the angle of arrival is determined for at least two base transceiver stations, the position of the mobile terminal is obtained as the intersection point of two straight lines. To execute this positioning method, directional antennas (such as antenna arrays) are needed at which the phase difference of the arriving wave at the individual antenna elements is measured. Thereby, an accuracy of less than 100 meters can be achieved.

As described above, there exist different technologies for determining the current location of a UE. And probably there are and will come other UE positioning methods in the future. Aside therefrom, the Nokia NetAct operating support system provides diverse network control and management features linked to the UE location data. For example, NetAct is able to trace incoming calls, collect UE performance indicators and follow the location of a UE on the cell level, which actually are the basic network operating control functions.

### SUMMARY

Unfortunately, reliable real-time RAN performance and functionality control on a cell level is relatively difficult and requires different and complex solutions for antenna, cable and active units monitoring. Today, many users are complaining about situations where a malfunction is detected only after some time when the network quality has already been deteriorated.

Moreover, there are a lot of unnecessary site visits due to false alarms which are initiated by antenna lines and active antenna line units in case of a deteriorated link quality.

An aspect is to provide for an easy solution which reliably solves the problems mentioned above so as to reduce the need for a complex and expensive hardware for performance monitoring.

A first exemplary embodiment is dedicated to a network management system having access to a base transceiver station's link performance monitoring system and location measurement unit, the latter being used for detecting current positioning information signals which are transmitted from a standard mobile terminal or any other, specific type of wireless user equipment via the air interface of a cellular wireless communication network (e.g. a mobile network according to the ETSI/BRAN, GSM, UMTS, Wi-Fi, W-LAN or IEEE 802.11 standard) to a base transceiver station of the network. Thereby, the network management system may include an integrated alarm signaling unit which may be adapted to generate a warning message or alarm signal if at least one continuously monitored radio link parameter indicating the quality of service in uplink and/or downlink direction of the current wireless link established between the base transceiver station and the mobile terminal or wireless user equipment, when the latter is moving, becomes worse than a predefined threshold value, and wherein the radio link parameter is derived from a current measurement of at least one positioning information signal transmitted from the mobile terminal or wireless user equipment to the base transceiver station.

the threshold value may e.g. indicate a specific value of the corresponding radio link parameter in a fixed range around a certain position of the mobile terminal or wireless user equipment in the mobile radio cell where the base transceiver station is located.

To be more precise, the alarm signaling unit may be adapted to generate the warning message or alarm signal based on the result of a comparison between a currently measured value of the continuously monitored signal-to-noise-plus-interference ratio and/or bit error rate of a positioning information signal transmitted over the wireless link between the base transceiver station and the mobile terminal or wireless user equipment and a previously measured, stored value of the corresponding radio link parameter which indicates the signal-to-noise-plus-interference ratio and/or bit error rate of the corresponding positioning information signal for the mobile terminal or wireless user equipment when being located within a fixed range around a predefined, known position within the aforementioned mobile radio cell.

Alternatively, the alarm signaling unit may be adapted to generate the warning message or alarm signal based on the result of a comparison between a currently measured value of the continuously monitored signal-to-noise-plus-interference ratio and/or bit error rate of a positioning information signal transmitted over the wireless link between the base transceiver station and the mobile terminal or wireless user equipment and a previously measured, stored value of the corresponding radio link parameter which indicates the signal-to-noise-plus-interference ratio and/or bit error rate of the corresponding positioning information signal for the mobile terminal or wireless user equipment when being located at a known position within the intersectional radio cell areas of at least two adjacent base transceiver stations within the coverage range of the cellular wireless communication network.

The described network management system may thereby include a storage unit with an integrated data base for recording and storing the positioning information and the corresponding radio link parameter.

According to a further aspect of the first embodiment, the alarm signaling unit may be adapted to generate different levels of a warning message or different levels of an alarm signal depending on the magnitude and/or algebraic sign of the difference between the measured value of the currently detected radio link parameter and the stored value of the corresponding radio link parameter characterizing the quality of service of the wireless link between the base transceiver station and the mobile terminal or wireless user equipment.

A second exemplary embodiment is dedicated to a base transceiver station which hosts a network management system having access to the base transceiver station's link performance monitoring system and location measurement unit, the latter being used for detecting current user equipment positioning information signals which are transmitted from a standard mobile terminal or any other, specific type of wireless user equipment via the air interface of a cellular radio access network to a base transceiver station of the network. Thereby, the network management system may include an integrated alarm signaling unit which may be adapted to generate a warning message or alarm signal if at least one continuously monitored radio link parameter indicating the quality of service in uplink and/or downlink direction of the current wireless link established between the base transceiver station and the mobile terminal or wireless user equipment, when the latter is moving, becomes worse than a predefined threshold value, and wherein the radio link parameter is derived from a current measurement of at least one positioning information signal transmitted from the mobile terminal or wireless user equipment to the base transceiver station.

Again, the threshold value may e.g. indicate a specific value of the corresponding radio link parameter in a fixed range around a certain position of the mobile terminal or wireless user equipment in the mobile radio cell in which the base transceiver station is located.

The alarm signaling unit may be adapted to generate the warning message or alarm signal based on the result of a comparison between a currently measured value of the continuously monitored signal-to-noise-plus-interference ratio and/or bit error rate of a positioning information signal transmitted over the wireless link between the base transceiver station and the mobile terminal or wireless user equipment and a previously measured, stored value of the corresponding radio link parameter which indicates the signal-to-noise-plus-interference ratio and/or bit error rate of the corresponding positioning information signal for the mobile terminal or wireless user equipment when being located within a fixed range around a predefined, known position within the aforementioned mobile radio cell.

As an alternative thereto, the alarm signaling unit may be adapted to generate the warning message or alarm signal based on the result of a comparison between a currently measured value of the continuously monitored signal-to-noise-plus-interference ratio and/or bit error rate of a positioning information signal transmitted over the wireless link between the base transceiver station and the mobile terminal or wireless user equipment and a previously measured, stored value of the corresponding radio link parameter which indicates the signal-to-noise-plus-interference ratio and/or bit error rate of the corresponding positioning information signal for the mobile terminal or wireless user equipment when being located at a known position within the intersectional radio cell areas of at least two adjacent base transceiver stations within the coverage range of the cellular radio access network.

The described network management system of the base transceiver station may thereby include a storage unit with an integrated data base for recording and storing the positioning information and the corresponding radio link parameter.

According to a further aspect of the second embodiment, the alarm signaling unit may be adapted to generate different levels of a warning message or different levels of an alarm signal depending on the magnitude and/or algebraic sign of the difference between the measured value of the currently detected radio link parameter and the stored value of the corresponding radio link parameter characterizing the quality of service of the wireless link between the base transceiver station and the mobile terminal or wireless user equipment.

A third exemplary embodiment is dedicated to a radio network controller for controlling the data transfer between a number of mobile terminals and base transceiver stations interconnected over the air interface of a fixed or mobile cellular radio access network, the radio network controller hosting a network management system having access to a base transceiver station's link performance monitoring system and location measurement unit, the latter being used for detecting current user equipment positioning information signals which are transmitted from a standard mobile terminal or any other, specific type of wireless user equipment via the air interface of the radio access network to a base transceiver station of the network. Thereby, the network management system may include an integrated alarm signaling unit which may be adapted to generate a warning message or alarm signal if at least one continuously monitored radio link parameter indicating the quality of service in uplink and/or downlink direction of the current wireless link established between the base transceiver station and the mobile terminal or wireless user equipment, when the latter is moving, becomes worse than a predefined threshold value, and wherein the radio link parameter is derived from a current measurement of at least one positioning information signal transmitted from the mobile terminal or wireless user equipment to the base transceiver station.

Again, the threshold value may e.g. indicate a specific value of the corresponding radio link parameter in a fixed range around a certain position of the mobile terminal or wireless user equipment in the mobile radio cell in which the base transceiver station is located.

The alarm signaling unit may be adapted to generate the warning message or alarm signal based on the result of a comparison between a currently measured value of the continuously monitored signal-to-noise-plus-interference ratio and/or bit error rate of a positioning information signal transmitted over the wireless link between the base transceiver station and the mobile terminal or wireless user equipment and a previously measured, stored value of the corresponding radio link parameter which indicates the signal-to-noise-plus-interference ratio and/or bit error rate of the corresponding positioning information signal for the mobile terminal or wireless user equipment when being located within a fixed range around a predefined, known position within the aforementioned mobile radio cell.

As an alternative thereto, the alarm signaling unit may be adapted to generate the warning message or alarm signal based on the result of a comparison between a currently measured value of the continuously monitored signal-to-noise-plus-interference ratio and/or bit error rate of a positioning information signal transmitted over the wireless link between the base transceiver station and the mobile terminal or wireless user equipment and a previously measured, stored value of the corresponding radio link parameter which indicates the signal-to-noise-plus-interference ratio and/or bit error rate of the corresponding positioning information signal for the mobile terminal or wireless user equipment when being located at a known position within the intersectional radio cell areas of at least two adjacent base transceiver stations within the coverage range of the cellular radio access network.

The described network management system of the radio network controller may thereby include a storage unit with an integrated data base for recording and storing the positioning information and the corresponding radio link parameter.

According to a further aspect of the third embodiment, the alarm signaling unit may be adapted to generate different levels of a warning message or different levels of an alarm signal depending on the magnitude and/or algebraic sign of the difference between the measured value of the currently detected radio link parameter and the stored value of the corresponding radio link parameter characterizing the quality of service of the wireless link between the base transceiver station and the mobile terminal or wireless user equipment.

A fourth exemplary embodiment is dedicated to a method for monitoring the link performance of a wireless link between a base transceiver station providing data of a requested location-based service and a standard mobile terminal or any other, specific type of wireless user equipment requesting this service and being connected to the base transceiver station via the air interface of a cellular wireless communication network (such as e.g. a mobile network according to the ETSI/BRAN, GSM, UMTS, Wi-Fi, W-LAN or IEEE 802.11 standard). Thereby, a warning message or alarm signal may be generated if at least one continuously monitored and newly measured radio link parameter indicating the quality of service in uplink and/or downlink direction of the current wireless link established between the base transceiver station and the mobile terminal or wireless user equipment, when the latter is moving, becomes worse than a predefined threshold value, and wherein the radio link parameter is derived from a current measurement of at least one positioning information signal transmitted from the mobile terminal or wireless user equipment to the base transceiver station.

Again, the threshold value may e.g. indicate a specific value of the corresponding radio link parameter in a fixed range around a certain position of the mobile terminal or wireless user equipment in the mobile radio cell in which the base transceiver station is located.

In this connection, the warning message or alarm signal may be generated based on the result of a comparison between a currently measured value of the continuously monitored and newly measured signal-to-noise-plus-interference ratio and/or bit error rate of a positioning information signal transmitted over the wireless link between the base transceiver station and the mobile terminal or wireless user equipment and a previously measured and stored value of the corresponding radio link parameter which indicates the signal-to-noise-plus-interference ratio and/or bit error rate of the corresponding positioning information signal for the mobile terminal or wireless user equipment when being located within a fixed range around a predefined, known position within the aforementioned mobile radio cell.

Alternatively, the warning message or alarm signal may be generated based on the result of a comparison between a currently measured value of the continuously monitored and newly measured signal-to-noise-plus-interference ratio and/or bit error rate of a positioning information signal transmitted over the wireless link between the base transceiver station and the mobile terminal or wireless user equipment and a previously measured and stored value of the corresponding radio link parameter which indicates the signal-to-noise-plus-interference ratio and/or bit error rate of the corresponding positioning information signal for the mobile terminal or wireless user equipment when being located at a known position within the intersectional radio cell areas of at least two adjacent base transceiver stations within the coverage range of the cellular wireless communication network.

According to a further aspect of the fourth embodiment, different levels of a warning message or different levels of an alarm signal may be generated depending on the magnitude and/or algebraic sign of the difference between the measured value of the currently detected radio link parameter and the stored value of the corresponding radio link parameter characterizing the quality of service of the wireless link between the base transceiver station and the mobile terminal or wireless user equipment.

A peculiarity of the method is that the network operator may transmit an antenna beam of a beacon type of signal from a base transceiver station in direction to a (previously triangulated or predefined) known fixed position (e.g. a building) within the coverage range of the cellular network and follow performance changes which might occur when the mobile terminal or specific wireless user equipment is moving towards this fixed position where the radio link parameter takes on a previously measured, known reference value. Beam widths and beam directions of the beacon signals should thereby be selected in such a way that base transceiver stations of several mobile radio cells can use them at the same time for monitoring the radio link parameters of a wireless link between the mobile terminal or specific user equipment and the respective base transceiver station.

A fifth exemplary embodiment is dedicated to the use of a base transceiver station's location measurement unit for gaining information about the quality of service in uplink and/or downlink direction of a wireless link via the air interface of a cellular mobile radio network between the base transceiver station and a mobile terminal or wireless user equipment connected to and being located in the same mobile radio cell as the base transceiver station. This may be achieved by measuring current values of at least one detected radio link parameter indicating the signal-to-noise-plus-interference ratio and/or bit error rate of a continuously monitored positioning information signal received from a mobile terminal or user equipment and comparing these current parameter values with at least one previously measured and stored value of the corresponding radio link parameter which indicates the signal-to-noise-plus-interference ratio and/or bit error rate of the corresponding positioning information signal for the mobile terminal or wireless user equipment when being located within a fixed range around a predefined, known position within the aforementioned mobile radio cell or when being located at a known position within the intersectional radio cell areas of at least two adjacent base transceiver stations within the coverage range of the cellular mobile radio network.

A sixth exemplary embodiment is dedicated to a computer program product for monitoring the link performance of a wireless link between a base transceiver station providing data of a requested location-based service and a standard mobile terminal or any other, specific type of wireless user equipment requesting this service and being connected to the base transceiver station via the air interface of a cellular wireless communication network (such as e.g. a mobile network according to the ETSI/BRAN, GSM, UMTS, Wi-Fi, W-LAN or IEEE 802.11 standard) when being installed and running on a network management system having access to the base transceiver station's link performance monitoring system and location measurement unit. Thereby, a warning message or alarm signal may be generated if at least one continuously monitored and newly measured radio link parameter indicating the quality of service in uplink and/or downlink direction of the current wireless link established between the base transceiver station and the mobile terminal or wireless user equipment, when the latter is moving, becomes worse than a predefined threshold value, and wherein the radio link parameter is derived from a current measurement of at least one positioning information signal transmitted from the mobile terminal or wireless user equipment to the base transceiver station.

Again, the threshold value may e.g. indicate a specific value of the corresponding radio link parameter in a fixed range around a certain position of the mobile terminal or wireless user equipment in the mobile radio cell in which the base transceiver station is located.

In this connection, the warning message or alarm signal may be generated based on the result of a comparison between a currently measured value of the continuously monitored and newly measured signal-to-noise-plus-interference ratio and/or bit error rate of a positioning information signal transmitted over the wireless link between the base transceiver station and the mobile terminal or wireless user equipment and a previously measured and stored value of the corresponding radio link parameter which indicates the signal-to-noise-plus-interference ratio and/or bit error rate of the corresponding positioning information signal for v mobile terminal or wireless user equipment when being located within a fixed range around a predefined, known position within the aforementioned mobile radio cell.

As an alternative thereto, the warning message or alarm signal may be generated based on the result of a comparison between a currently measured value of the continuously monitored and newly measured signal-to-noise-plus-interference ratio and/or bit error rate of a positioning information signal transmitted over the wireless link between the base transceiver station and the mobile terminal or wireless user equipment and a previously measured and stored value of the corresponding radio link parameter which indicates the signal-to-noise-plus-interference ratio and/or bit error rate of the corresponding positioning information signal for the mobile terminal or wireless user equipment when being located at a known position within the intersectional radio cell areas of at least two adjacent base transceiver stations within the coverage range of the cellular wireless communication network.

According to a further aspect of the sixth embodiment, different levels of a warning message or different levels of an alarm signal may be generated depending on the magnitude and/or algebraic sign of the difference between the measured value of the currently detected radio link parameter and the stored value of the corresponding radio link parameter characterizing the quality of service of the wireless link between the base transceiver station and the mobile terminal or wireless user equipment.

### BRIEF DESCRIPTION OF THE DRAWINGS

These and other aspects and advantages will become more apparent and more readily appreciated from the following description of exemplary embodiments, taken in conjunction with the accompanying drawings of which:

FIG. 1 is a block diagram of a distributed Universal Terrestrial Radio Access Network (UTRAN) in which the method described below may advantageously be applied;

FIG. 2 is a block diagram of a general system for user equipment positioning within an UTRAN;

FIG. 3 is a block diagram illustrating a communication scenario for illustrating a location registering procedure in a public land mobile network;

FIG. 4 is a block diagram illustrating a communication scenario for illustrating the call delivering procedure in such a public land mobile network;

FIG. 5A is a block diagram illustrating an initial communication scenario for a wireless signaling between a base transceiver station and a mobile terminal located in a mobile radio cell of a wireless cellular network, wherein the mobile terminal is located at a defined position (in the following also referred to as “beacon spot”) within the mobile radio cell and wherein positioning information as contained in a wirelessly received positioning information signal is recorded to the base transceiver station of the respective cell along with measured radio link parameters in uplink and/or downlink direction of the received positioning information signal;

FIG. 5B is a block diagram illustrating a further communication scenario for a wireless signaling between the base transceiver station and the mobile terminal, wherein the mobile terminal is moving and approaching to the beacon spot or to a location within a defined range around the above-mentioned beacon spot and wherein the measured radio link parameters are compared to the recorded ones when the received positioning information indicates that the mobile terminal is currently located within the beacon spot;

FIG. 5C is a block diagram illustrating a still further communication scenario for a wireless signaling between the base transceiver station and a wireless signaling equipment, wherein the wireless signaling equipment is located at a known fixed position within the intersectional radio cell areas of at least two adjacent base transceiver stations within the coverage range of the cellular mobile radio network;

FIG. 6 is a block diagram of the system components as contained in a base transceiver station; and

FIGS. 7A-7C are a flowchart of a method for monitoring the link performance of a wireless link between a base transceiver station providing data of a requested location-based service and a standard mobile terminal or any other, specific type of wireless user equipment requesting this service and being connected to the base transceiver station via the air interface of a cellular wireless network

### DETAILED DESCRIPTION OF THE EXEMPLARY EMBODIMENTS

Reference will now be made in detail to the exemplary embodiments which are illustrated in the accompanying drawings, wherein like reference numerals refer to like elements throughout.

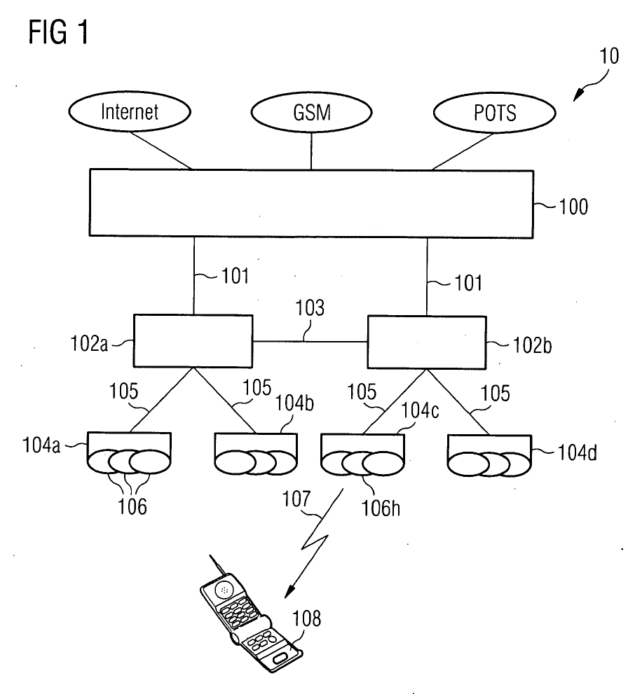

FIG. 1 shows a schematic block diagram of a distributed network 10 according to the Universal Terrestrial Radio Access Network (UTRAN) standard in the scope of which the method described below may advantageously be applied. Radio Network Controllers (RNC) 102a, 102b thereby perform the control of communication connections and network resources respectively of a number of base transceiver stations and are responsible to provide connections to a Core Network 100. RNCs 102a and 102b are connected to “Node B's” 104a-d, wherein one Node B includes one or more base transceiver stations 106. Each base transceiver station 106 controls the UEs within its covered cell area. Due to the above-mentioned distinction, the RNC may have various roles: Regarding the network resources, RNC 102b acts as a controlling RNC (C-RNC) which is responsible for the control of resources of a part of the network including a number of cells, each of which serving a plurality of UEs 108. Regarding the communication connections, an RNC 102a or 102b acts as the serving RNC (S-RNC) for those connections which terminate in that RNC. However, when a UE 108 moves during an ongoing session from a first RNC 102a, which is the S-RNC for the corresponding communication connection, to a neighboring RNC 102b, the original RNC 102a still remains the S-RNC for this connection while the second RNC 102b, which is in control of the resources that this connection uses, is a drift RNC (D-RNC) that supports the S-RNC 11a with the necessary radio resources; however, without any influence on the connection. Thus, the D-RNC controls at least one cell that is used in a radio connection controlled by a serving RNC and supplies the S-RNC with resources.

Thus, it is a problem, as previously described, that positioning information, that is only based on the cell-ID, is not accurate enough and may hence imply disadvantages for services where a more exact location of the UEs is required.

Another problem is that an S-RNC cannot get sufficient positioning information of a UE that has roamed during an ongoing session to a D-RNC, which provides network resources for the UE, while the S-RNC still controls the connection of the UE.

In order to better understand how location measurement units and Radio Network Controllers work, it is helpful to briefly describe the architecture of a Universal Terrestrial Radio Access Network (UTRAN). Although the content of this section mainly deals with 3^{rd} and 4^{th} generation wireless systems operated according to the Universal Mobile Telecommunication System (UMTS) standard, it should be mentioned that it is also relevant to the Global System for Mobile Communication (GSM) standard.

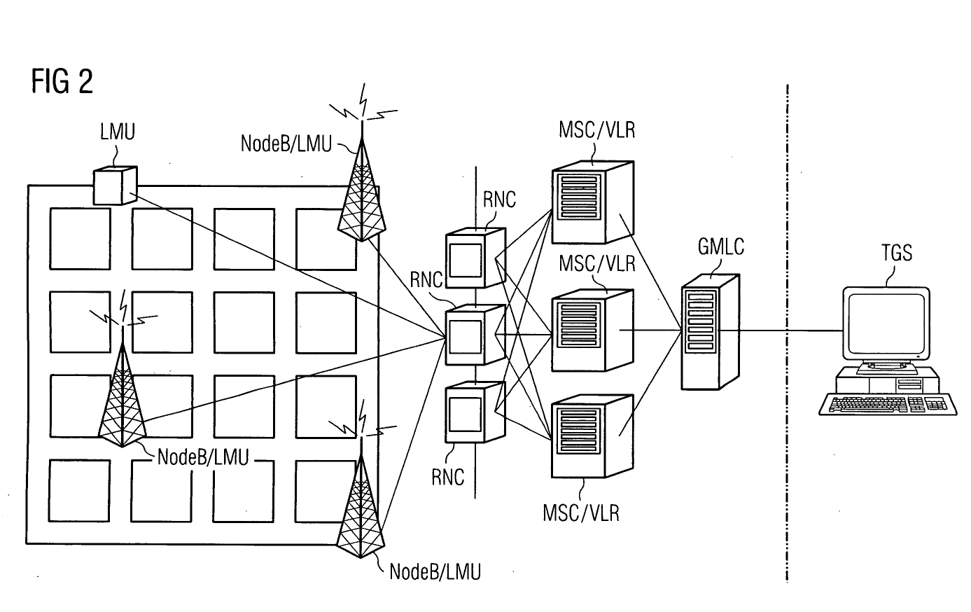

FIG. 2 shows a general system for user equipment positioning within such a UTRAN. A Node B (here referred to as a single base transceiver station BTS) is a network element of UTRAN that may provide measurements for position estimation, make measurements of radio signals and communicate these measurements to the core network. A location measurement unit (LMU), on the other hand, is a dedicated positioning device that makes radio measurements to support at least one positioning method or technology. There are two classes of LMUs: “stand-alone LMUs” and “associated LMUs”. A stand-alone LMU is accessed exclusively via the air interface, which means that there is no other connection from a stand-alone LMU to any other network element. However, an associated LMU may make use of the radio apparatus and antennas of its associated Node B. Radio Network Controllers (RNCs) play an important role under the UMTS standard. They can be classified into “controlling RNCs” (CRNCs), “serving RNCs” (SRNCs) and “drift RNCs” (DRNCs):
CRNCs manage positioning-related resources, broadcast system information, and request UE positioning related measurements from its associated Node B's and LMUs. All positioning and assistance measurements received by an LMU are supplied to a particular CRNC associated with the LMU. Instructions concerning the timing, the nature and any periodicity of these measurements are either provided by the CRNC or are pre-administered in the CRNC.
SRNCs request information from other RNCs, control the flow of positioning requests, select the positioning method, provide UE positioning assistance data, and coordinate and control the overall UE positioning task. The SRNC, of course, also provides CRNC functionality with respect to UE positioning for its associated Node B's and LMUs.
A DRNC is an UTRAN element having an active link to the UE that is being located. The DRNC also provides CRNC functionality with respect to UE positioning for its associated Node B's and LMUs.

The Mobile Switching Centers (MSC) or Visitor Location Registers (VLR) as depicted in FIG. 2 have a functionality associated with user subscription authorization and managing call-related (and non-call-related) positioning requests of a Location Service (LCS). They also perform handover algorithm functions and mobility management. Location-related services of the MSC/VLRs are related to charging and billing, LCS coordination, location request, authorization and operation of LCS services offered by an LCS server.

A Gateway Mobile Location Center (GMLC) as depicted in FIG. 2 is the first node of a public land mobile network (PLMN) that is accessed by an external LCS client. It has the functionality required to support the LCS. As shown in FIG. 2, the GMLC may be connected to a telegeoinformatics server (TGS) which resides outside the core network.

Location management is a two-stage process that enables the network to discover the current attachment point of the mobile user for call delivery. The first stage is location registration (or location update). In this stage, the mobile terminal periodically notifies the network of its new access point, allowing the network to authenticate the user and revise the user's location profile. The second stage is call delivery. Thereby, the network is queried for the user location profile and the current position of the mobile host is found. Current schemes for location management in public land mobile networks are based on a two-level data hierarchy such that two types of network location data base, the home location register (HLR) and the visitor location register (VLR), are involved in tracking a mobile terminal (MT). In general, there is an HLR for each network and a user is permanently associated with an HLR in his/her subscribed network. Information about each user, such as e.g. the types of services subscribed and location information, are stored in a user profile located at the HLR. The number of VLRs and their placements vary among networks. Each VLR stores the information of the MTs (downloaded from the HLR) visiting its associated area. Each VLR is associated with one or more Mobile Switching Centers (MSCs), while a signaling network assures the connection among MSC, HLR and VLR. Signaling System 7 (SS10) is the protocol used for signaling exchange, and the signaling network is referred to as the SS10 network. For PLMN, the location registration procedures update the location data bases (HLR and VLRs) and authenticate the MT when up-to-date location information of an MT is available. The call delivery procedures locate the MT based on the information available at the HLR and the VLRs when a call for a MT is initiated.

To correctly deliver calls, the network must keep track of the location of the MT. The location information is stored in two types of data base, VLR and HLR. As the MT moves around the coverage area, the data stored in these data bases may no longer be accurate. To ensure that calls can be delivered successfully, the location registration updating process is performed. The MT initiates location registration when it reports its current location to the network; this location update is performed whenever the MT enters a new location area (LA). Each LA may consist of a number of cells and all the base transceiver stations belonging to the same LA are connected to the same MSC. All the base transceiver stations within the same LA broadcast the ID of its LA periodically. When the MT enters a LA, it compares its registered LA ID with the current broadcast LA ID; location update is triggered if the two IDs are different. If the new LA belongs to the same VLR as the old LA, the record at the VLR is updated to record the ID of the new LA. Otherwise, if the new LA belongs to a different VLR, a number of extra steps are required to register the MT at the new serving VLR, update the HLR to record the ID of the new serving VLR and deregister the MT at the old serving VLR.

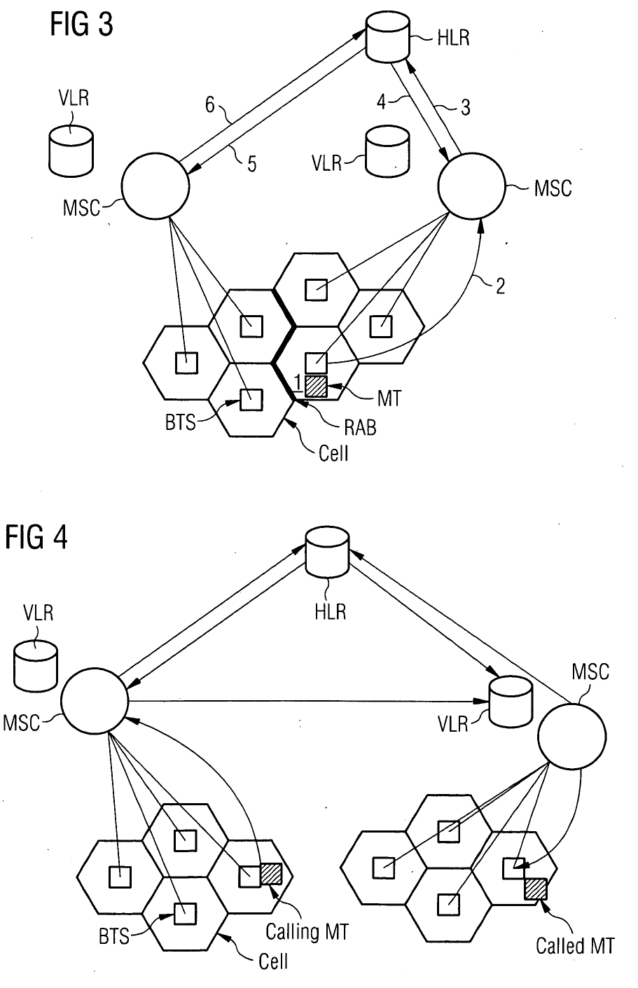

FIG. 3 shows the location registration procedure when the MT moves to a new LA. The following is the ordered list of tasks that are performed during location registration:
1. The MT enters a new LA and transmits a location update message to the new BS.
2. The BTS forwards the location update message to the MSC through a wired link, which launches a registration query to its associated VLR.
3. The VLR updates its record on the location of the MT. If the new LA belongs to a different VLR, the new VLR determines the address of the HLR of the MT from its mobile identification number (MIN). This is achieved by a table lookup procedure called global title translation. The new VLR then sends a location registration message to the HLR; otherwise, location registration is complete.
4. The HLR performs the required procedures to authenticate the MT and records the ID of the new serving VLR of the MT. The HLR then sends a registration acknowledgment message to the new VLR.
5. The HLR sends a registration cancellation message to the old VLR.
6. The old VLR removes the record of the MT and returns a cancellation acknowledgment message to the HLR.

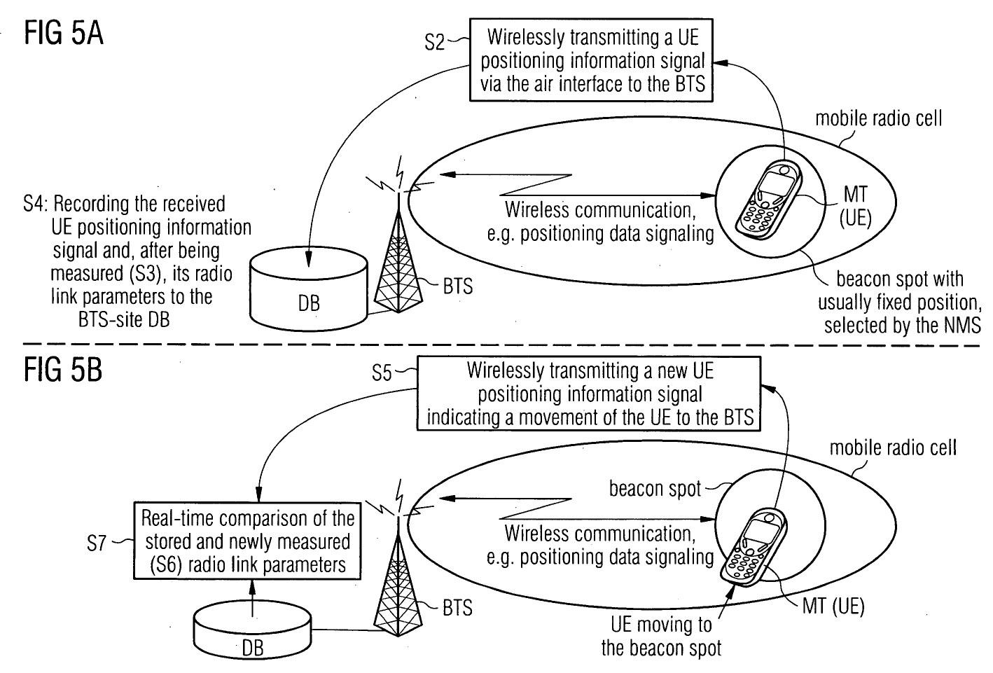

Two major steps are involved in call delivery: determining the serving VLR of the called MT, and locating the visiting cell of the called MT. Locating the serving VLR of the MT involves the following data base lookup procedure (see FIG. 4):
1. The calling MT sends a call initiation signal to the serving MSC of the MT through a nearby BS.
2. The MSC determines the address of the HLR of the called MT by global title translation and sends a location request message to the HLR.
3. The HLR determines the serving VLR of the called MT and sends a route request message to the VLR. This VLR then forwards the message to the MSC serving the MT.
4. The MSC allocates a temporary identifier called temporary location directory number (TLDN) to the MT and sends a reply to the HLR together with the TLDN.
5. The HLR forwards this information to the MSC of the calling MT.
6. The calling MSC requests a call set up to the called MSC through the SS10 network.
7. The called MSC initiates a paging procedure within the current LA of the MT, and the MT replies in order to receive the call.

The procedure described above allows the network to set up a connection from the calling MT to the serving MSC of the called MT. Since each MSC is associated with a LA, and there is more than one cell in each LA is therefore necessary to determine the cell location of the called MT. This is accomplished by a paging procedure such that polling signals are broadcasted to all cells within the residing LA of the called MT. On receiving the polling signal, the MT sends a reply, which allows the MSC to determine its current residing cell.

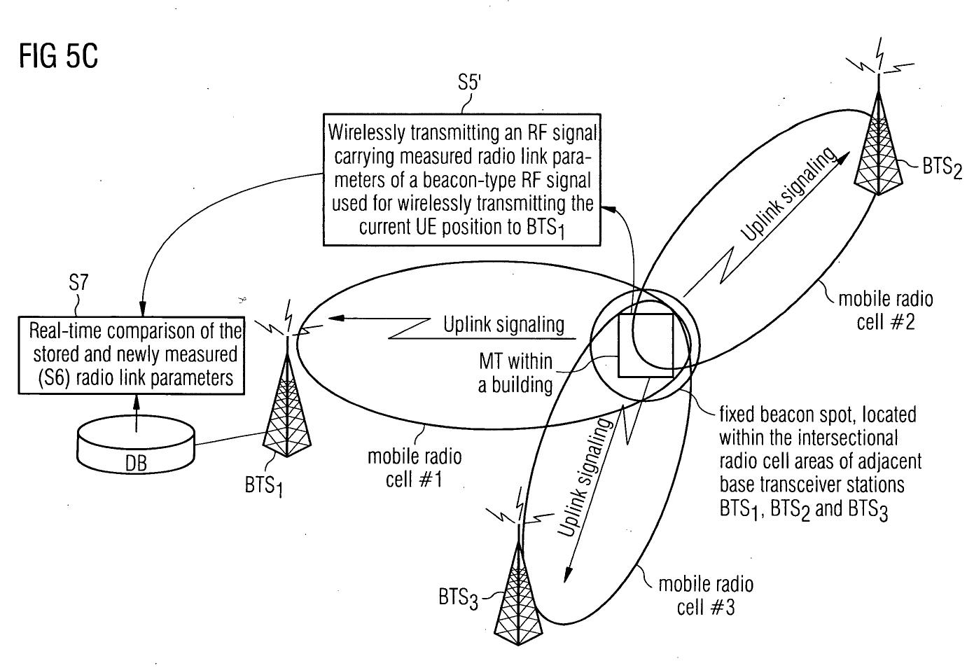

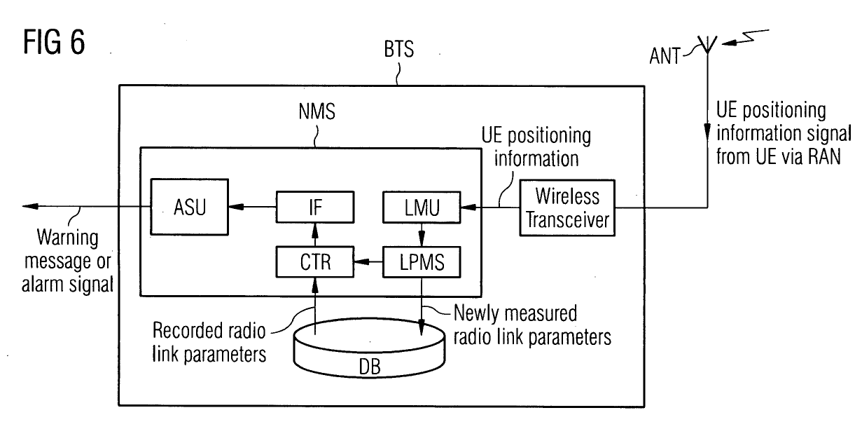

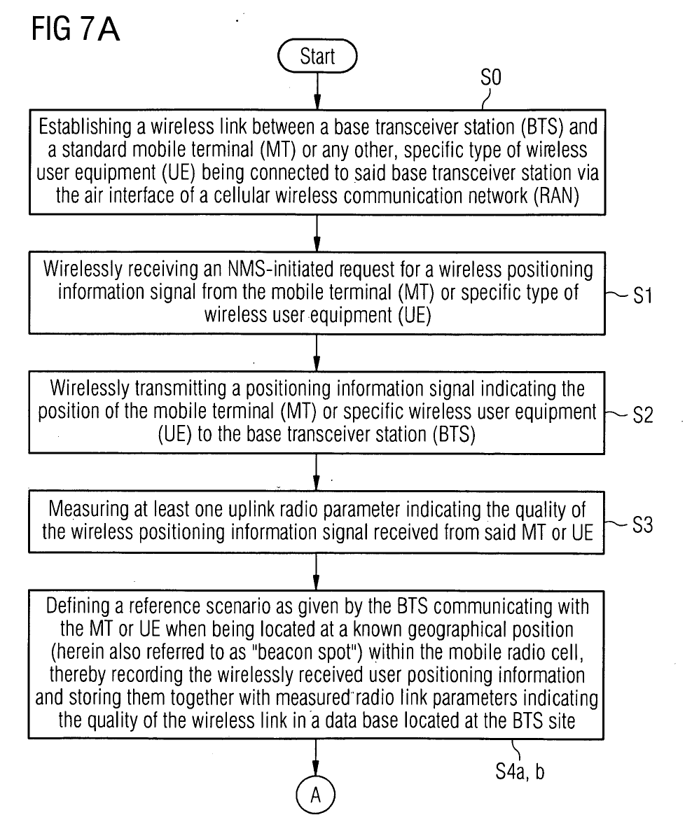

FIG. 5A shows an initial communication scenario for a wireless signaling between a base transceiver station and a mobile terminal located in a mobile radio cell of a wireless cellular network. In this communication scenario, the mobile terminal is located at a defined position (in the following also referred to as “beacon spot”) within the mobile radio cell. A wireless RF signal which is used for carrying positioning information indicating the current location of the mobile terminal is transmitted to the base transceiver station of the corresponding mobile radio cell. In the base transceiver station, where the RF signal is wirelessly received, the positioning information is stored in an integrated data base along with measured radio link parameters (signal-to-noise-plus-interference ratio, bit error rate, etc.) which are derived from the received positioning information signal. These radio link parameters thereby indicate the quality of service of the respective wireless link between the mobile terminal and the base transceiver station in uplink and/or downlink direction.

In FIG. 5B, a further communication scenario for a wireless signaling between the base transceiver station and the mobile terminal is shown. Therein, the mobile terminal is moving and approaching to the beacon spot or to a location within a defined range around the beacon spot. The depicted scenario shows that currently measured radio link parameters indicating the quality of service of the respective wireless link between the mobile terminal and the base transceiver station are compared with corresponding radio link parameters which have previously been recorded for the mobile terminal when the received positioning information indicates that the respective mobile terminal is currently located within the beacon spot.

FIG. 5c finally shows a still further communication scenario for a wireless signaling between the base transceiver station and a wireless signaling equipment. In contrast to the communication scenarios described above, the wireless signaling equipment may e.g. be located at a known fixed position within the intersectional radio cell areas of at least two adjacent base transceiver stations within the coverage range of the cellular mobile radio network. At this position, all measured radio link parameter take on previously measured, known reference values. Accordingly, wireless positioning information signals which are received at any one of these base transceiver stations may be used for radio network performance monitoring. This may e.g. be done in that a network operator may transmit an antenna beam of a beacon type of signal from a base transceiver station in direction to the known fixed position and follow performance changes which might occur when the mobile terminal MT or specific wireless user equipment UE is moving towards or away from this fixed position. Beam widths and beam directions of the beacon signals should thereby be selected in such a way that base transceiver stations of several mobile radio cells can use them at the same time for monitoring the radio link parameters of a wireless link between the mobile terminal or specific user equipment and the respective base transceiver station, which has also been mentioned above.

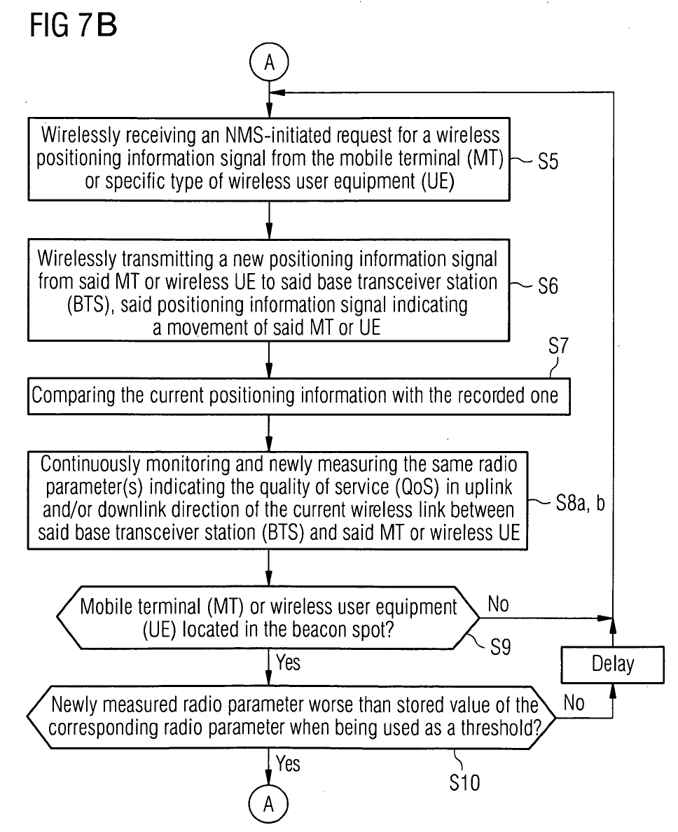

A schematic block diagram of the system components as contained in a base transceiver station BTS is depicted in FIG. 6. the base transceiver station thereby includes a network management system NMS having access to the base transceiver station's link performance monitoring system LPMS and location measurement unit LMU, wherein the latter, as described above, is used for detecting current positioning information signals which are received from a standard mobile terminal MT or any other, specific type of wireless user equipment UE via the air interface of a wireless communication network, wherein the network may e.g. be given by a mobile network according to the ETSI/BRAN, GSM, UMTS, Wi-Fi, W-LAN or IEEE 802.11 standard. The depicted network management system is further equipped with an integrated alarm signaling unit ASU which may be adapted to generate a warning message or alarm signal if at least one continuously monitored radio link parameter indicating the quality of service (QoS) in uplink and/or downlink direction of the current wireless link established between the base transceiver station BTS and the mobile terminal MT or wireless user equipment UE, when the latter is moving, becomes worse than a predefined threshold value or previously measured, known radio link parameter stored in a BTS-site data base DB. As described above, the radio link parameter is derived from a current measurement of at least one positioning information signal transmitted from the mobile terminal MT or wireless user equipment UE to the base transceiver station BTS. The above-described comparison of the currently measured radio link parameter and the stored value of the corresponding radio link parameter is done by the processor of a controller CTR which is connected to the alarm signaling unit ASU via control data output interface IF.

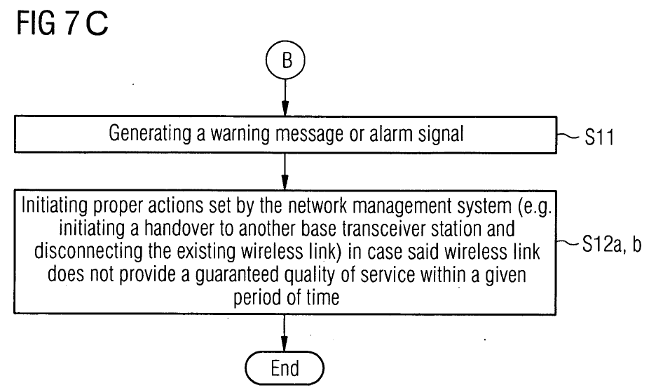

FIG. 7 shows a three-part flow chart which illustrates the above-described method. After having established (S0) a wireless link between a base transceiver station BTS and a standard mobile terminal MT or any other, specific type of wireless user equipment UE being connected to the base transceiver station via the air interface of a cellular wireless communication network (such as e.g. a mobile network according to the ETSI/BRAN, GSM, UMTS, Wi-Fi, W-LAN or IEEE 802.11 standard) and having received (S1) an NMS-initiated request for a wireless positioning information signal from the mobile terminal MT or specific wireless user equipment UE, a positioning information signal indicating the position of the mobile terminal MT or wireless user equipment UE is wirelessly transmitted (S2) via the air interface of the cellular wireless communication network to the base transceiver station BTS. The link performance monitoring system LPMS of the base transceiver station BTS then measures (S3) at least one uplink radio parameter indicating the quality of service of the wireless link from the received positioning information signal. After that, a reference scenario as given by the BTS communicating with the MT or wireless UE when being located at a known geographical position (“beacon spot”) within the mobile radio cell is defined, thereby recording (S4a) the received user positioning information and storing (S4b) them together with the measured radio link parameters indicating the quality of the wireless link in a data base DB which is located at the BTS site. After having received (S5) an NMS-initiated request for a wireless positioning information signal from the mobile terminal MT or wireless user equipment UE, the mobile terminal MT or wireless user equipment UE wirelessly transmits (S6) new positioning information to the base transceiver station BTS which may e.g. indicate a movement of the mobile terminal MT or wireless user equipment UE. The current positioning information is then compared (S7) with the recorded positioning information which is stored in the data base. The base transceiver station thereby continuously monitors (S8a) and newly measures (S8b) the same radio link parameter(s) indicating the quality of service (QoS) in uplink and/or downlink direction of the current wireless link between the base transceiver station BTS and the mobile terminal MT or wireless user equipment UE. If the mobile terminal MT or wireless user equipment UE is located in the beacon spot, which is determined by the query in S9, and if the newly measured radio link parameter(s) are worse than stored value of the corresponding radio link parameter(s) when being used as a threshold, which is asked in query S10, alarm signaling unit ASU generates (S11) a warning message or alarm signal. Otherwise, the procedure is again continued with S5. In case the wireless link does not provide a guaranteed quality of service within a given period of time, proper actions set by the network management system NMS are taken. For example, a handover procedure for executing a handover to another base transceiver station may be initiated (S12a), and the existing wireless link may be disconnected (S12b).

Practical examples of frequently offered location-based services in the scope of which the method described above can advantageously be applied are e.g. location-based services which are used for providing emergency information for a district (e.g. closing of a park, fire alarms, warning of dangers), for advertising (inauguration of a new shop, announcement for the beginning of an event in a few minutes), for triggering a service if the user enters a specific area (e.g. offering of specific information therefor), for changing to a better (or cheaper) type of connection link (such as e.g. W-LAN, Bluetooth etc.) or for triggering a service, if the user stays at the same place for a certain period of time (e.g. when queuing at a cash desk or in front of <A[in front of|before]> an entrance, when regarding a display or poster, waiting at a bus stop, etc.). Other examples of application may be informing the user when approaching to a specific place, e.g. a restaurant or a hotel, informing the user when approaching to a specific other user (such as e.g. a friend, a job<A[job|work]> colleague, another player of a game the user is involved, etc.) or to a specific appliance (such as e.g. a parking ticket automat), informing the user, if a person or appliance leaves a certain area (theft protection system, child leaves party, etc.), location-dependent accounting of call charges (in particular, the subscriber must be informed that the accounting of call charges changes if he/she leaves or enters a certain area) as well as statistical evaluations (such as e.g. determining the number of mobile devices in a certain area for better recognition of a traffic jam or reacting to the raised demand for public transport after the end of a mass event, such as e.g. a concert, sport event etc.). Location-based service information can also be broadcasted within a cell such that all mobile terminals which are located in this cell can receive this information. The mechanisms of the location-based services are specified in “Location Services (LCS). Service Description. Stage 1” (3GPP TS 22.071, 3rd Generation Partnership Project) and “Functional Stage 2: Description of Location Services (LCS)” (3GPP TS 23.271, 3rd Generation Partnership Project) by the Technical Specification Group Services and System Aspects. Basically a so-called “LCS client” (e.g. a software unit in the mobile terminal or in the net) requires accordingly a location-dependent service at a “LCS server”, that determines the position of the mobile terminal then and provides the corresponding service the enquiring “LCS client”.

While the present invention has been illustrated and described in detail in the drawings and in the foregoing description, such illustration and description are to be considered illustrative or exemplary and not restrictive, which means that the invention is not limited to the disclosed embodiments. Other variations to the disclosed embodiments can be understood and effected by those skilled in the art in practicing the method, from a study of the drawings and the text of the disclosure. In the claims, a single processor or other unit may fulfill the functions of several items recited in the claims. The mere fact that certain measures are recited in mutually different dependent claims does not indicate that a combination of these measures can not be used to advantage. A computer program may be stored/distributed on a suitable medium, such as an optical storage medium or a solid-state medium supplied together with or as part of other hardware, but may also be distributed in other forms, such as e.g. via the Internet or other wired or wireless telecommunication systems. The system can output the results to a display device, printer, readily accessible memory or another computer on a network.

A description has been provided with particular reference to exemplary embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

What is claimed is:

1. A network management system having access to a link performance monitoring system and a location measurement unit, both of a base transceiver station, the location measurement unit being used for detecting current positioning information signals which are transmitted from user equipment via a wireless interface of a cellular wireless communication network to the base transceiver station of the cellular wireless communication network, said network management system comprising:
an integrated alarm signaling unit generating a warning message or alarm signal if at least one continuously monitored radio link parameter indicating quality of service in uplink and/or downlink direction of a current wireless link established between the base transceiver station and the user equipment, when the user equipment is moving, becomes worse than a predefined threshold value, and the at least one continuously monitored radio link parameter is derived from a current measurement of at least one positioning information signal transmitted from the user equipment to the base transceiver station.

2. The network management system according to claim 1, wherein the predefined threshold value indicates a specific value of a corresponding radio link parameter in a fixed range around a certain position of the user equipment in a mobile radio cell in which the base transceiver station is located.

3. The network management system according to claim 2, wherein said integrated alarm signaling unit generates the warning message or the alarm signal based on a result of a comparison between a currently measured value of a continuously monitored signal-to-noise-plus-interference ratio and/or a bit error rate of a positioning information signal transmitted over the current wireless link between the base transceiver station and the user equipment and a previously measured, stored value of the corresponding radio link parameter which indicates the signal-to-noise-plus-interference ratio and/or the bit error rate of a corresponding positioning information signal for the user equipment when being located within a fixed range around a predefined, known position within the mobile radio cell.

4. The network management system according to claim 2, wherein said integrated alarm signaling unit generates the warning message or the alarm signal based on a result of a comparison between a currently measured value of a continuously monitored signal-to-noise-plus-interference ratio and/or a bit error rate of a positioning information signal transmitted over the current wireless link between the base transceiver station and the user equipment and a previously measured, stored value of the corresponding radio link parameter which indicates the signal-to-noise-plus-interference ratio and/or the bit error rate of a corresponding positioning information signal for the user equipment when being located at a known position within intersectional radio cell areas of at least two adjacent base transceiver stations within a coverage range of the cellular wireless communication network.

5. The network management system according to claim 4, further comprising a storage unit with an integrated database recording and storing positioning information and the corresponding radio link parameter.

6. The network management system according to claim 5, wherein said alarm signaling unit generates different levels of a warning message or different levels of an alarm signal depending on a magnitude and/or algebraic sign of a difference between the currently measured value of the at least one continuously monitored radio link parameter and the stored value of the corresponding radio link parameter indicating the quality of service of the current wireless link between the base transceiver station and the user equipment.

7. A base transceiver station which hosts a network management system having access to a link performance monitoring system and a location measurement unit, both of the base transceiver station, the location measurement unit detecting current user equipment positioning information signals which are transmitted from user equipment via a wireless interface of a cellular radio access network to said base transceiver station, comprising:
an integrated alarm signaling unit generating a warning message or an alarm signal if at least one continuously monitored radio link parameter indicating quality of service in uplink and/or downlink direction of a current wireless link established between said base transceiver station and the user equipment, when the user equipment is moving, becomes worse than a predefined threshold value, where the at least one continuously monitored radio link parameter is derived from a current measurement of at least one positioning information signal transmitted from the user equipment to said base transceiver station.

8. The base transceiver station according to claim 7, wherein the predefined threshold value indicates a specific value of a corresponding radio link parameter in a fixed range around a certain position of the user equipment in a mobile radio cell in which said base transceiver station is located.

9. The base transceiver station according to claim 8, wherein said alarm signaling unit generates the warning message or the alarm signal based on a result of a comparison between a currently measured value of a continuously monitored signal-to-noise-plus-interference ratio and/or a bit error rate of a positioning information signal transmitted over the current wireless link between said base transceiver station and the user equipment and a previously measured, stored value of the corresponding radio link parameter which indicates the continuously monitored signal-to-noise-plus-interference ratio and/or the bit error rate of a corresponding positioning information signal for the user equipment when located within a fixed range around a predefined, known position within a mobile radio cell.

10. The base transceiver station according to claim 8, wherein said alarm signaling unit generates the warning message or the alarm signal based on a result of a comparison between a currently measured value of a continuously monitored signal-to-noise-plus-interference ratio and/or a bit error rate of a positioning information signal transmitted over the wireless link between said base transceiver station and the user equipment and a previously measured, stored value of the corresponding radio link parameter which indicates the continuously monitored signal-to-noise-plus-interference ratio and/or a bit error rate of a corresponding positioning information signal for the user equipment when located at a known position within intersectional radio cell areas of at least two adjacent base transceiver stations within a coverage range of a cellular radio access network.

11. The base transceiver station according to claim 10, further comprising a storage unit with an integrated database for recording and storing positioning information and the corresponding radio link parameter.

12. The base transceiver station according to claim 11, wherein said alarm signaling unit generates different levels of a warning message or different levels of an alarm signal depending on a magnitude and/or an algebraic sign of a difference between the currently measured value of the at least one continuously monitored radio link parameter and the stored value of the corresponding radio link parameter characterizing quality of service of the current wireless link between said base transceiver station and the user equipment.

13. A radio network controller for controlling data transfer between mobile terminals and base transceiver stations interconnected over a wireless interface of a radio access network which is fixed or mobile cellular, said radio network controller hosting a network management system having access to a link performance monitoring system and a location measurement unit, both of a base transceiver station, the location measurement unit detecting current user equipment positioning information signals which are transmitted from user equipment via a wireless interface of the radio access network to one of the base transceiver stations of the radio access network, said radio network controller comprising:
an integrated alarm signaling unit generating a warning message or an alarm signal if at least one continuously monitored radio link parameter indicating quality of service in uplink and/or downlink direction of a current wireless link established between the one of the base transceiver stations and the user equipment, when the user equipment is moving, becomes worse than a predefined threshold value, and the at least one continuously monitored radio link parameter is derived from a current measurement of at least one positioning information signal transmitted from the user equipment to the one of the base transceiver stations.

14. The radio network controller according to claim 13, wherein the predefined threshold value indicates a specific value of a corresponding radio link parameter in a fixed range around a certain position of the user equipment in a mobile radio cell in which the one of the base transceiver stations is located.

15. The radio network controller according to claim 14, wherein said integrated alarm signaling unit generates the warning message or the alarm signal based on a result of a comparison between a currently measured value of the continuously monitored signal-to-noise-plus-interference ratio and/or a bit error rate of the at least one positioning information signal and a previously measured, stored value of the corresponding radio link parameter which indicates the continuously monitored signal-to-noise-plus-interference ratio and/or a bit error rate of a corresponding positioning information signal for the user equipment when located within a fixed range around a predefined, known position within the mobile radio cell.

16. The radio network controller according to claim 14, wherein said alarm signaling unit generates the warning message or the alarm signal based on a result of a comparison between a currently measured value of the continuously monitored signal-to-noise-plus-interference ratio and/or a bit error rate of a positioning information signal transmitted over the wireless link between the one of the base transceiver stations and the user equipment and a previously measured, stored value of a corresponding positioning information signal which indicates the continuously monitored signal-to-noise-plus-interference ratio and/or a bit error rate of a corresponding positioning information signal for the user equipment when located at a known position within intersectional radio cell areas of at least two adjacent base transceiver stations within a coverage range of a cellular radio access network.

17. The radio network controller according to claim 16, wherein the network management system includes a storage unit with an integrated database for recording and storing positioning information and the corresponding radio link parameter.

18. The radio network controller according to claim 17, wherein said alarm signaling unit generates different levels of a warning message or different levels of an alarm signal depending on a magnitude and/or an algebraic sign of a difference between a currently measured value of the at least one continuously monitored radio link parameter and the stored value of the corresponding radio link parameter indicating the quality of service of the current wireless link between the one of the base transceiver stations and the user equipment.

19. A method for monitoring the link performance of a wireless link between user equipment and a base transceiver station providing data of a location-based service requested by the user equipment requesting which is connected to the base transceiver station via a wireless interface of a cellular wireless communication network, comprising:
generating a warning message or an alarm signal if at least one continuously monitored and newly measured radio link parameter indicating quality of service in uplink and/or downlink direction of a current wireless link established between the base transceiver station and the user equipment, when the user equipment is moving, becomes worse than a predefined threshold value, and where the newly measured radio link parameter is derived from a current measurement of at least one positioning information signal transmitted from the user equipment to the base transceiver station.

20. The method according to claim 19, wherein the predefined threshold value indicates a specific value of a corresponding radio link parameter in a fixed range around a certain position of the user equipment in a mobile radio cell in which the base transceiver station is located.

21. The method according to claim 20, wherein the warning message or the alarm signal is generated based on a result of a comparison between a currently measured value of a continuously monitored and newly measured signal-to-noise-plus-interference ratio and/or a bit error rate of a positioning information signal transmitted over the current wireless link between the base transceiver station and the user equipment and a previously measured and stored value of the corresponding radio link parameter which indicates the signal-to-noise-plus-interference ratio and/or the bit error rate of a corresponding positioning information signal for the user equipment when located within a fixed range around a predefined, known position within the mobile radio cell.

22. The method according to claim 20, wherein the warning message or the alarm signal is generated based on a result of a comparison between a currently measured value of a continuously monitored and newly measured signal-to-noise-plus-interference ratio and/or a bit error rate of a positioning information signal transmitted over the current wireless link between the base transceiver station and the user equipment and a previously measured and stored value of the corresponding radio link parameter which indicates the signal-to-noise-plus-interference ratio and/or the bit error rate of a corresponding positioning information signal for the user equipment when located at a known position within intersectional radio cell areas of at least two adjacent base transceiver stations within a coverage range of the cellular wireless communication network.

23. The method according to claim 22, wherein different levels of the warning message or different levels of the alarm signal are generated depending on a magnitude and/or an algebraic sign of a difference between the currently measured value of the continuously monitored and newly measured radio link parameter and the stored value of the corresponding radio link parameter indicating the quality of service of the current wireless link between the base transceiver station and the user equipment.

24. A method of using a location measurement unit of a base transceiver station for gaining information about quality of service in uplink and/or downlink direction of a wireless link via a wireless interface of a cellular mobile radio network between the base transceiver station and user equipment connected to and located in a same mobile radio cell as the base transceiver station, comprising:
measuring current values of at least one detected radio link parameter indicating a signal-to-noise-plus-interference ratio and/or a bit error rate of a continuously monitored positioning information signal received from the user equipment; and
comparing the current values of the at least one detected radio link parameter with at least one previously measured and stored value of a corresponding radio link parameter which indicates a signal-to-noise-plus-interference ratio and/or a bit error rate of a corresponding positioning information signal for the user equipment when located within a fixed range around a predefined, known position within the same mobile radio cell or when located at a known position within intersectional radio cell areas of at least two adjacent base transceiver stations within a coverage range of the cellular mobile radio network.

25. A computer-readable medium encoded with a computer program that when exected by at least one processor causes the at least one processor to perform a method of monitoring link performance of a wireless link between user equipment and a base transceiver station providing data of a location-based service requested by the user equipment which is connected to the base transceiver station via a wireless interface of a cellular wireless communication network when installed and running on a network management system having access to a link performance monitoring system and location measurement unit, both of the base transceiver station, said method comprising:
generating a warning message or an alarm signal if at least one continuously monitored and newly measured radio link parameter indicating quality of service in uplink and/or downlink direction of a current wireless link established between the base transceiver station and the user equipment, when the user equipment is moving, becomes worse than a predefined threshold value, and wherein the radio link parameter is derived from a current measurement of at least one positioning information signal transmitted from the user equipment to the base transceiver station.

26. The computer-readable medium according to claim 25, wherein the predefined threshold value indicates a specific value of a corresponding radio link parameter in a fixed range around a certain position of the user equipment in a mobile radio cell in which the base transceiver station is located.

27. The computer-readable medium according to claim 26, wherein the warning message or the alarm signal is generated based on a result of a comparison between a currently measured value of the continuously monitored and newly measured signal-to-noise-plus-interference ratio and/or a bit error rate of a positioning information signal transmitted over the current wireless link between the base transceiver station and the user equipment and a previously measured and stored value of the corresponding radio link parameter which indicates a signal-to-noise-plus-interference ratio and/or a bit error rate of a corresponding positioning information signal for the user equipment when located within a fixed range around a predefined, known position within the mobile radio cell.

28. The computer-readable medium according to claim 26, wherein the warning message or the alarm signal is generated based on a result of a comparison between a currently measured value of the continuously monitored and newly measured signal-to-noise-plus-interference ratio and/or a bit error rate of a positioning information signal transmitted over the current wireless link between the base transceiver station and the user equipment and a previously measured and stored value of the corresponding radio link parameter which indicates the signal-to-noise-plus-interference ratio and/or bit error rate of a corresponding positioning information signal for the user equipment when being located at a known position within intersectional radio cell areas of at least two adjacent base transceiver stations within a coverage range of the cellular wireless communication network.

29. The computer-readable medium according to claim 28, wherein different levels of a warning message or different levels of an alarm signal are generated depending on a magnitude and/or an algebraic sign of a difference between the currently measured value of the continuously monitored and newly measured radio link parameter and the stored value of the corresponding radio link parameter indicating the quality of service of the current wireless link between the base transceiver station and the user equipment.
